(19) United States
(12) Patent Application Publication
(10) Pub. No.: US 2007/0075056 A1
(43) Pub. Date: Apr. 5, 2007

(54) Soldering device and method for forming electrical solder connections in a disk drive unit

(75) Inventors: YiuSing Ho, HongKong (CN); GuoHong Lu, DongGuan (CN)

Correspondence Address: NIXON & VANDERHYE, PC, 901 NORTH GLEBE ROAD, 11TH FLOOR, ARLINGTON, VA, 22203, US

(73) Assignee: SAE Magnetics (H.K.) Ltd., Hong Kong (CN)

(21) Appl. No.: 11/238,997

(22) Filed: Sep. 30, 2005

(51) Int. Cl. B23K 26/00

(52) U.S. Cl. 219/121.66

(57) ABSTRACT

A soldering device for forming electrical solder connections in a disk drive unit includes a bond head, a laser unit, a pressurized gas supply, and a solder ball supply. The bond head includes a housing that provides a primary passage and two supplemental passages that communicate with the primary passage. The laser unit is operable to direct a laser beam through the primary passage. The pressurized gas supply is operable to deliver pressurized gas through one supplemental passage and into the primary passage. The solder ball supply is operable to deliver a single solder ball through the other supplemental passage and into the primary passage. The primary passage has a tapered configuration structured to maintain a solder ball within the primary passage to allow a laser beam from the laser unit to act upon the solder ball before the solder ball is discharged from the bond head by pressurized gas.

### FIELD OF THE INVENTION

The present invention relates to a disk drive unit and, more particularly, to a soldering device and method for forming electrical solder connections in a disk drive unit.

### BACKGROUND OF THE INVENTION

One known type of information storage device is a disk drive unit that uses magnetic media to store data and a movable read/write head that is positioned over the media to selectively read from or write to the disk.

FIGS. 1-2 illustrate a typical disk drive unit 10 that includes a motor base assembly 12, a top cover 14, and a printed circuit board assembly (PCBA) 16. As illustrated, the motor base assembly 12 includes a head stack assembly (HSA) 18 with slider(s) 20 thereon (see FIG. 3), a magnetic disk 22 mounted on a spindle motor 24 for spinning the disk 22, and a motor base 26 to enclose the above-mentioned components. The slider(s) 20 flies over the surface of the magnetic disk 22 at a high velocity to read data from or write data to the concentric data tracks on the magnetic disk 22, which is positioned radially by a voice coil 28 embedded, e.g., by epoxy potting or overmolding, in a fantail spacer 30 of the HSA 18 (see FIG. 3). Generally, a voice-coil motor (VCM) is used to drive the voice coil 28.

As shown in FIGS. 3-4, a typical HSA 18 includes two head gimbal assemblies (HGAs) 32 and 34, a fantail spacer 30 (incorporating a voice coil 28) interposed between the HGA 32 and the HGA 34, a plurality of securing means to couple the two HGAs 32 and 34 with the fantail spacer 30, and a flex printed circuit (FPC) 36 aligned with the fantail spacer 30 by a FPC assembly 38 to electrically connect with the two HGAs 32 and 34, the fantail spacer 30, and the voice coil 28.

Each HGA 32 and 34 includes a suspension 40 that supports a slider 20 thereon. As illustrated, the plurality of securing means includes a bearing 42, a washer 44, and a nut 46. A mounting hole 48 is formed in the suspension base plate 50 of each suspension 40 and a mounting hole 52 is formed in the fantail spacer 30. The mounting holes 48, 52 are provided to permit the bearing 42 to extend therethrough so as to combine the above-mentioned components together with the washer 44 and the nut 46 as shown in FIG. 3.

Each HGA 32 and 34 includes a suspension trace that extends from the slider 20 to a trace terminal 54 provided on the suspension flexure. The slider 20 includes slider pads that are electrically connected to adjacent suspension pads of the suspension trace. Also, the trace terminal 54 includes suspension pads 56 that are electrically connected to the FPC assembly 38.

Specifically, the FPC assembly 38 provides a plurality of FPC pads including voice coil connection pads 58, a grounding pin connection pad 60, and FPC pads 62. When the HSA 18 is assembled, the FPC 36 is initially assembled to the fantail spacer 30 by electrically connecting the voice coil connection pads 58 with respective voice coil leads 64 of the voice coil 28 and electrically connecting the grounding pin connection pad 60 with a grounding pin 66 provided on the fantail spacer 30. Then, the HGAs 32 and 34 (with respective sliders 20 connected thereto) are secured by the securing means to the fantail spacer 30, and the suspension pads 56 of the HGAs 32 and 34 are electrically connected with the FPC pads 62 of the FPC assembly 38. After that, the assembled HSA 18 is mounted in the motor base 26, and the FPC 36 is electrically connected to the PCBA 16 to form the disk drive unit 10.

As noted above, assembly of the disk drive unit 10 includes electrical connections between the (1) the slider 20 and the suspension 40, (2) the suspension flexure and the FPC 36, (3) the FPC 36 and the grounding pin 66 provided on the fantail spacer 30, (4) the FPC 36 and the voice coil leads 64 provided on the fantail spacer 30, and (5) the FPC 36 and the PCBA 16. Conventional methods for forming these electrical connections have several disadvantages.

For example, a conventional method to connect the slider 20 and the suspension 40 includes gold ball bonding (GBB). However, GBB is difficult to rework, and cannot be applied to small slider pads and small pitch. Also, GBB includes ESD issues.

A conventional method to connect the suspension flexure and the FPC 36 includes USB, ACF, or conventional solder. However, USB is sensitive to material with weak mechanical strength, therefore requiring a conformal coating for protection. ACF is difficult to rework and therefore cannot be used for multi head bonding. Conventional solder requires significant room for pad layout.

A conventional method to connect the FPC 36 and the grounding pin 66 includes manual solder or screw tightening. However, manual solder or screw tightening can result in component contamination.

A conventional method to connect the FPC 36 and the voice coil leads 64 includes manual solder. However, manual solder can result in component contamination.

A conventional method to connect the FPC 36 and the PCBA 16 includes conventional solder or male/female connector. However, conventional solder can result in component contamination, and the male/female connector requires significant room which is unsuitable for micro drives.

Thus, while the conventional methods described above provide an effective solution for connection, they also include several drawbacks. Therefore, a need has developed in the art to provide improvements to known devices and methods for forming electrical connections in a disk drive unit.

### SUMMARY OF THE INVENTION

One aspect of the present invention relates to a soldering device for forming electrical solder connections in a disk drive unit that uses pressurized gas and a laser beam to provide a melted solder ball jet.

Another aspect of the invention relates to a soldering device for forming electrical solder connections in a disk drive unit. The soldering device includes a bond head, a laser unit, a pressurized gas supply, and a solder ball supply. The bond head includes a housing that provides a primary passage and two supplemental passages that communicate with the primary passage. The laser unit is coupled to the primary passage and is operable to direct a laser beam through the primary passage. The pressurized gas supply is coupled to one of the supplemental passages and is operable to deliver pressurized gas through the one supplemental passage and into the primary passage. The solder ball supply is coupled to the other of the supplemental passages and is operable to deliver a single solder ball through the other supplemental passage and into the primary passage. The primary passage has a tapered configuration structured to maintain a solder ball within the primary passage to allow a laser beam from the laser unit to act upon the solder ball before the solder ball is discharged from the bond head by the pressurized gas.

Yet another aspect of the present invention relates to a method for forming electrical solder connections in a disk drive unit. The method includes delivering a solder ball into a passage of a bond head, melting the solder ball within the passage by a laser beam, and discharging the melted solder ball from the passage by pressurized gas onto a desired solder location.

Still another aspect of the present invention relates to a bond head for a soldering device that forms electrical solder connections in a disk drive unit. The bond head includes a housing that provides a primary passage structured to receive a solder ball from a solder ball supply. The primary passage has a tapered configuration in which an inner diameter of the primary passage adjacent an outlet is sufficiently smaller than a diameter of a solder ball received from the solder ball supply whereby the solder ball is maintained within the primary passage adjacent the outlet.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

The accompanying drawings facilitate an understanding of the various embodiments of this invention. In such drawings:

FIG. 1 is a perspective view of a conventional disk drive unit;

FIG. 2 is an exploded view of the disk drive unit shown in FIG. 1;

FIG. 3 is a perspective view of a conventional head stack assembly (HSA) provided in the disk drive unit shown in FIG. 1;

FIG. 4 is an exploded view of the HSA shown in FIG. 3;

FIGS. 5A-5D illustrate a soldering device and method for forming electrical solder connections in a disk drive unit according to an embodiment of the present invention;

FIG. 6 is a perspective view illustrating a slider being electrically connected to a suspension of a head gimbal assembly by the soldering device and method of FIGS. 5A-5D;

FIGS. 7-8 illustrate the completed electrical solder connection between the slider and suspension of FIG. 6;

FIG. 9 is a perspective view illustrating a flex printed circuit (FPC) being aligned with a fantail spacer;

FIG. 10 is a perspective view illustrating the FPC and fantail spacer of FIG. 9 with the FPC being connected to a grounding pin provided on the fantail spacer by the soldering device and method of FIGS. 5A-5D;

FIG. 11 is a cross-sectional view illustrating the FPC being connected to a grounding pin provided on the fantail spacer by the soldering device and method of FIGS. 5A-5D;

FIG. 12 is a cross-sectional view illustrating the completed electrical solder connection between the FPC and grounding pin of FIGS. 10-11;

FIG. 13 is a perspective view illustrating the FPC and fantail spacer of FIG. 9 with the FPC being connected to voice coil leads provided on the fantail spacer by the soldering device and method of FIGS. 5A-5D;

FIG. 14 is a cross-sectional view illustrating the FPC being connected to a voice coil lead provided on the fantail spacer by the soldering device and method of FIGS. 5A-5D;

FIGS. 15-16 are cross-sectional views illustrating the completed electrical solder connection between the FPC and voice coil lead of FIGS. 13-14;

FIG. 17 is a perspective view illustrating the HSA of FIG. 3 with the suspension flexure of a head gimbal assembly being electrically connected to the FPC by the soldering device and method of FIGS. 5A-5D;

FIG. 18 is an enlarged view of the suspension pads provided on the suspension flexure of the head gimbal assembly shown in FIG. 17;

FIG. 19 is a cross-sectional view of a suspension pad shown in FIG. 18;

FIG. 20 is a cross-sectional view of a FPC pad provided on the FPC shown in FIG. 17;

FIG. 21 is a cross-sectional view illustrating the suspension flexure and FPC of FIGS. 17-20 being electrically connected by the soldering device and method of FIGS. 5A-5D;

FIG. 22 is a cross-sectional view illustrating the completed electrical solder connection between the suspension flexure and FPC of FIGS. 17-21;

FIG. 23 is a perspective view illustrating another embodiment of a HSA including two head gimbal assemblies and a fantail spacer with a FPC;

FIG. 24 is an enlarged view of the suspension pads provided on the suspension flexure of a head gimbal assembly shown in FIG. 23;

FIG. 25 is a cross-sectional view of a suspension pad shown in FIG. 24;

FIG. 26 is a cross-sectional view of a FPC pad provided on the FPC shown in FIG. 23;

FIG. 27 is an enlarged view of another embodiment of suspension pads that may be provided on the suspension flexure of a head gimbal assembly shown in FIG. 23;

FIGS. 28-29 are perspective views illustrating the HSA of FIG. 23 with the suspension flexures of the head gimbal assemblies being electrically connected to the FPC by the soldering device and method of FIGS. 5A-5D;

FIG. 30 is a cross-sectional view illustrating the suspension flexure and FPC of FIGS. 23-29 being electrically connected by the soldering device and method of FIGS. 5A-5D;

FIG. 31 is a cross-sectional view illustrating the completed electrical solder connection between the suspension flexure and FPC of FIGS. 23-30;

FIG. 32 is a perspective view illustrating yet another embodiment of a HSA including two head gimbal assemblies and a fantail spacer with a FPC;

FIG. 33 is a perspective view illustrating the HSA of FIG. 32 with the suspension flexures of the head gimbal assemblies being electrically connected to the FPC by the soldering device and method of FIGS. 5A-5D;

FIG. 34 is a cross-sectional view illustrating the suspension flexures and FPC of FIGS. 32-33 being electrically connected by the soldering device and method of FIGS. 5A-5D;

FIG. 35 is a cross-sectional view illustrating the disk drive unit of FIG. 2 with the FPC of the HSA being electrically connected to the printed circuit board assembly (PCBA) by the soldering device and method of FIGS. 5A-5D; and

FIG. 36 is a cross-sectional view illustrating the completed electrical solder connection between the FPC and PCBA of FIG. 35.

### DETAILED DESCRIPTION OF ILLUSTRATED EMBODIMENTS

Various preferred embodiments of the present invention will now be described with reference to the figures, wherein like reference numerals designate similar parts throughout the various views. As indicated above, the present invention is designed to improve the soldering device and method for forming electrical solder connections in a disk drive unit.

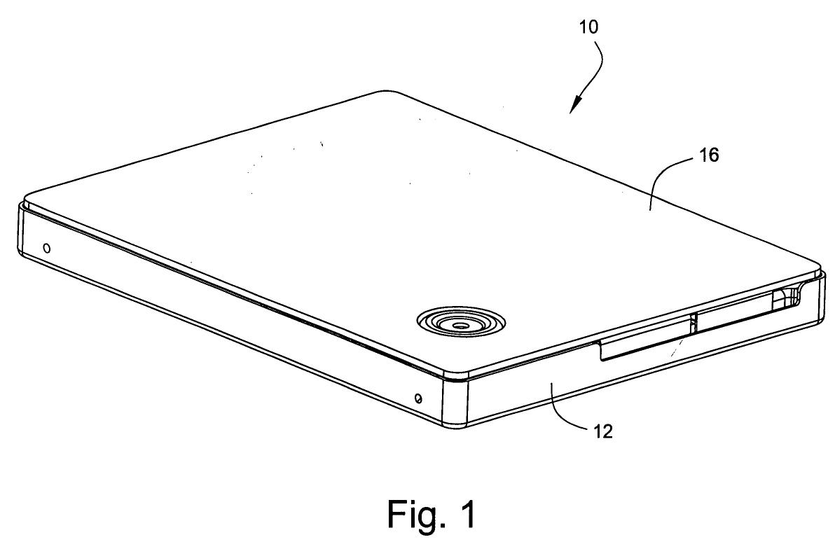

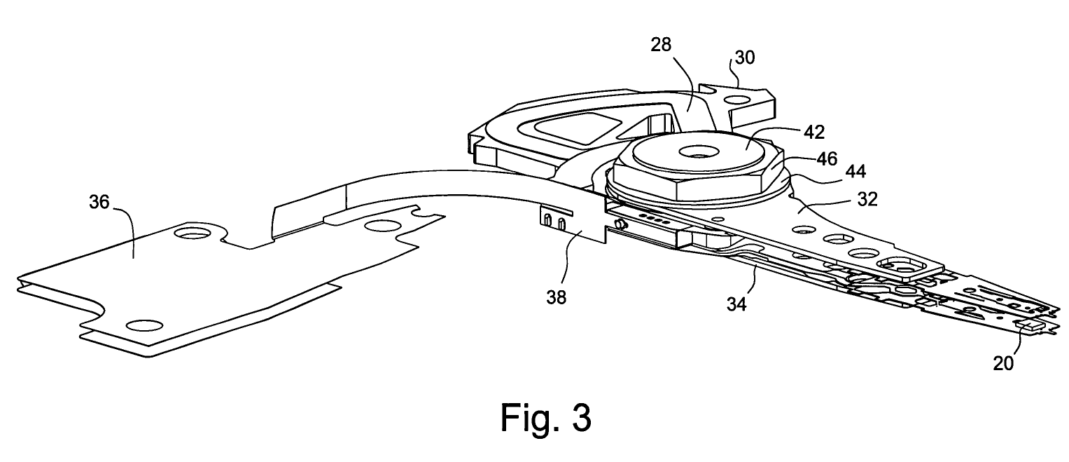

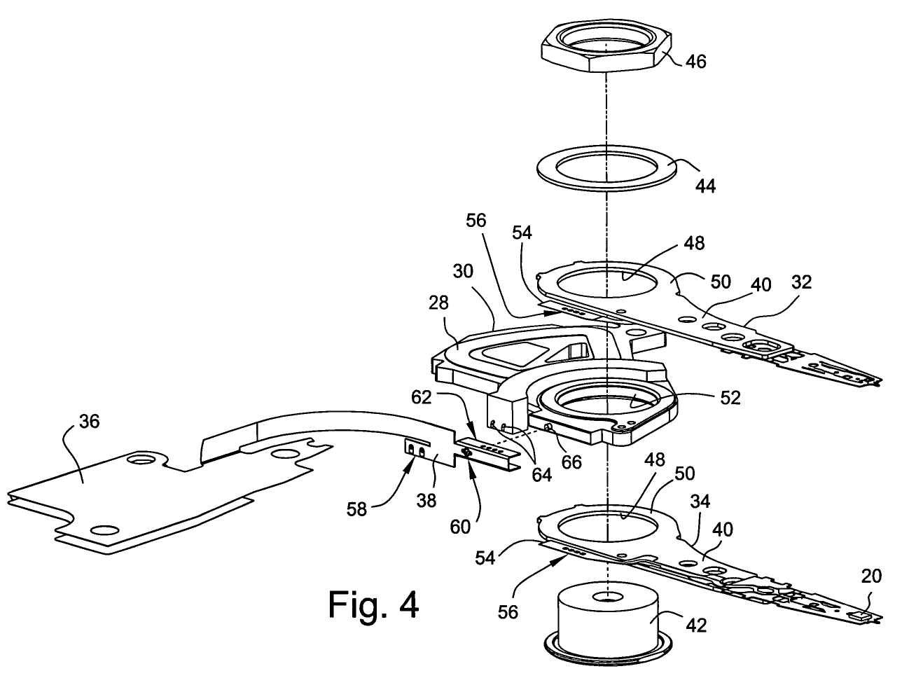

A soldering device and method for forming electrical solder connections in a disk drive unit according to an embodiment of the present invention will now be described. The example embodiment is illustrated in the figures and described as being implemented in the assembly of a conventional disk drive unit of the type described above in connection with FIGS. 1-4. However, it is noted that the invention is not limited to such implementations. Instead, the soldering device and method can be implemented in the assembly of any suitable disk drive device having components which require electrical solder connection, regardless of the specific structure of the disk drive unit and HSA thereof.

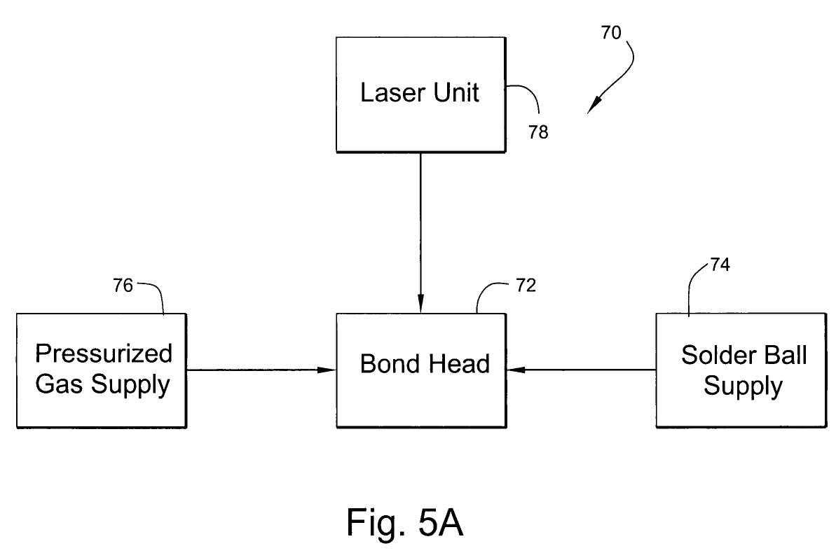

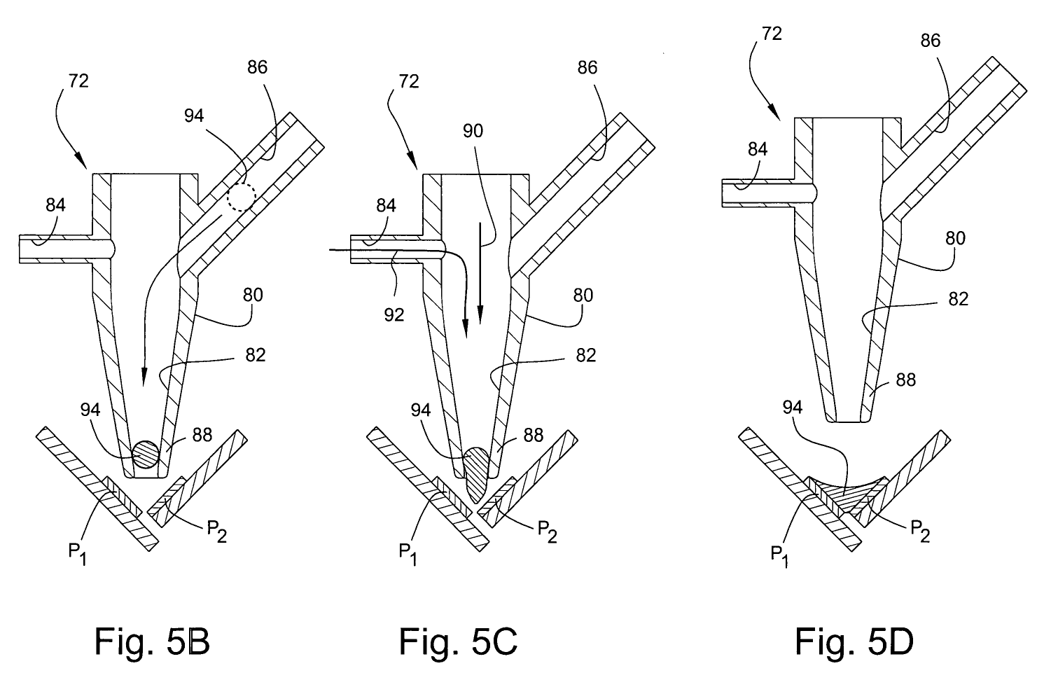

FIG. 5A illustrates a soldering device 70 constructed according to an embodiment of the present invention. The soldering device 70 includes a bond head 72 that is coupled to a solder ball supply 74, a pressurized gas supply 76, and a laser unit 78.

As shown in FIGS. 5B-5D, the bond head 72 includes a housing 80 that provides a primary passage 82 (also referred to as a primary capillary) and two supplemental passages 84, 86 that communicate with the primary passage 82. As illustrated, the primary passage 82 includes a tapered configuration such that the inner diameter of the primary passage 82 gradually decreases towards the head or outlet 88.

The primary passage 82 is coupled to the laser unit 78 such that a laser beam 90 (e.g., see FIG. 5C) from the laser unit 78 can be directed through the primary passage 82. The laser unit 78 may have any suitable structure to supply a laser beam 90 suitable to create the desired solder connection. The supplemental passage 84 is coupled to the pressurized gas supply 76 such that pressurized gas 92 (e.g., see FIG. 5C) from the supply 76 can be delivered through the supplemental passage 84 and into the primary passage 82. The supplemental passage 86 is coupled to the solder ball supply 74 such that a single solder ball 94 (e.g., see FIG. 5B) from the supply 74 can be delivered through the supplemental passage 86 and into the primary passage 82. The solder balls 94 may be constructed from any suitable material. Also, the solder balls 94 from the supply 74 have diameters that are controlled or predetermined.

In use, the bond head 72 is positioned adjacent the desired solder location, e.g., adjacent two bonding pads P₁ and P₂, as shown in FIG. 5B. The solder ball supply 74 is actuated to deliver a single solder ball 94 into the primary passage 82. The primary passage 82 is tapered such that the inner diameter of the primary passage 82 adjacent the head 88 is sufficiently smaller than the diameter of the single solder ball 94. Thus, the solder ball 94 has a larger diameter than the diameter of the primary passage 82 adjacent the head 88. As a result, the solder ball 94 delivered into the primary passage 82 is blocked and maintained within the primary passage 82 adjacent the head 88 as shown in FIG. 5B.

Then, the laser unit 78 is actuated to direct a laser beam 90 through the primary passage 82 and onto the solder ball 94 adjacent the head 88 as shown in FIG. 5C. The laser beam 90 is configured to melt the solder ball 94 within the primary passage 82. Thus, the solder ball 94 has no contact with the bonding pads P₁ and P₂ before the laser unit 78 is actuated. As the laser beam 90 melts the solder ball 94 within the primary passage 82, the pressurized gas supply 76 is actuated to direct pressurized gas 92 through the primary passage 82 and onto the melting solder ball 94 as shown in FIG. 5C. The pressurized gas 92 discharges or jets the melted solder ball 94 from the bond head 72 and onto the bonding pads P₁ and P₂. That is, the bond head 72 delivers a melted solder ball jet 92 onto the desired solder location as shown in FIG. 5C. The melted solder 92 reflows to achieve the desired connection between the bonding pads P₁ and P₂ as shown in FIG. 5D. Moreover, the pressurized gas 92 is preferably an inert gas, which prevents oxidation during the jetting process.

The soldering device and method described in FIGS. 5A-5D has several advantages. For example, no additional force/pressure is applied onto the bonding pads due to no-touch bonding, so there is little or no deformation to the components being connected. This is particularly advantageous for slider bonding to improve PSA/RSA (Pitch Static Attitude/Roll Static Attitude) performance. The device and method provides good ESD performance due to no-touch bonding. The device and method has no contamination issues, and provides flux free reflow with the laser beam. Also, the device and method provide excellent electrical and mechanical performance. Additionally, the device and method provide high efficiency, e.g., jet around six solder balls per second. Further, the device and method enables a solder ball to be applied to high density and small room for interconnection. Moreover, the device and method enables the solder to be easily reworked.

It is noted that the tapered configuration of the bond head 72, the pressure of the pressurized gas 92, the laser beam 90, and the solder ball structure and dimension may be suitably adjusted depending on application.

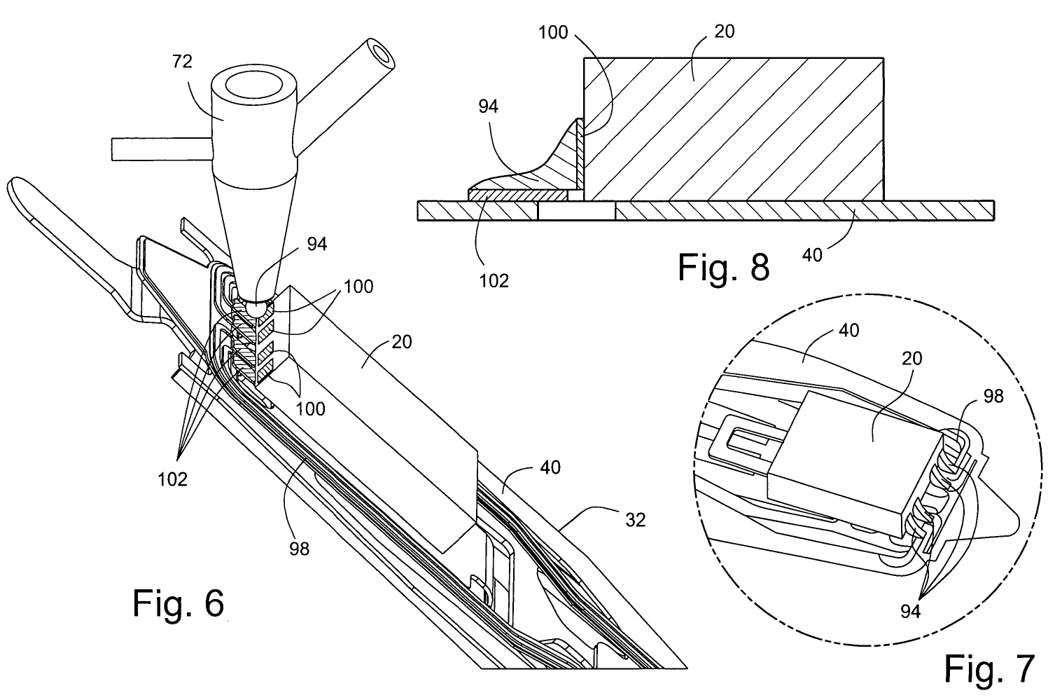

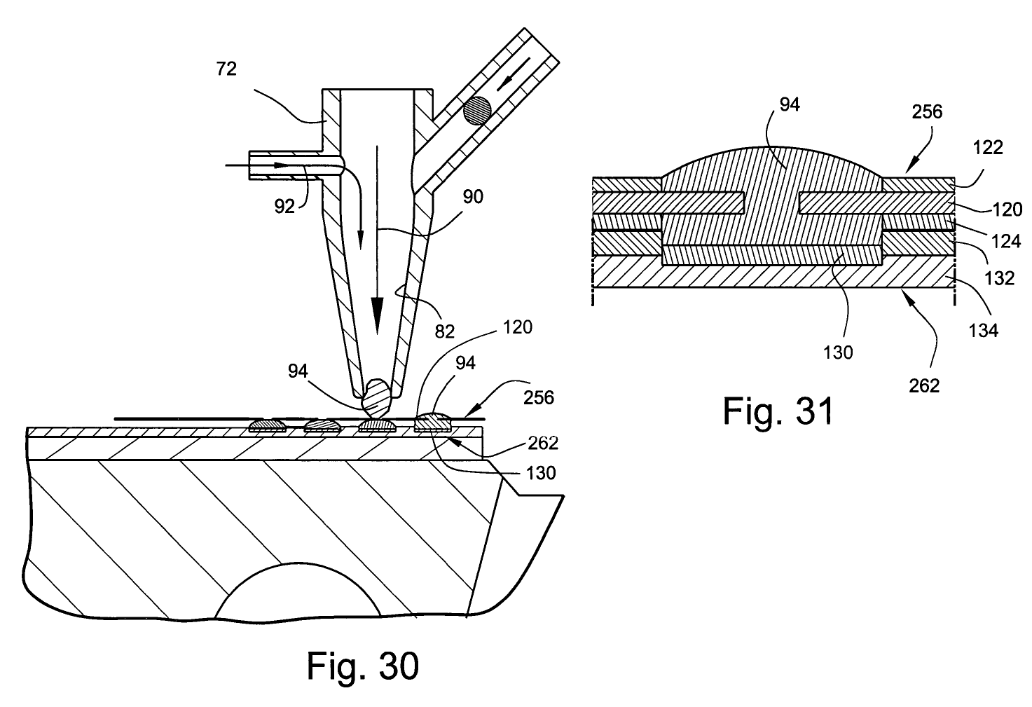

The soldering device and method described in FIGS. 5A-5D may be utilized to form electrical solder connections between various components of a disk drive unit. For example, FIGS. 6-36 illustrate the soldering device and method of FIGS. 5A-5D being utilized to form electrical solder connections between (1) the slider and suspension, (2) the FPC and the grounding pin provided on the fantail spacer, (3) the FPC and the voice coil leads provided on the fantail spacer, (4) the suspension flexure and the FPC, and (5) the FPC and the PCBA.

FIGS. 6-8 illustrate the soldering device and method of FIGS. 5A-5D being utilized to form electrical solder connections between the slider 20 and suspension 40 of a HGA 32. The slider 20 is initially mounted, e.g., using an epoxy, on a suspension tongue of the suspension 40. It is noted that the slider 20 and suspension 40 may have any suitable structure, and the slider 20 may be mounted to the suspension 40 in any suitable manner.

Next, the slider 20 is electrically connected to the suspension traces 98 provided on the suspension 40 of the HGA 32. As shown in FIG. 6, the slider 20 includes a plurality of slider pads 100, e.g., four slider pads, that are aligned with respective suspension pads 102 of the suspension traces 98. The slider pads 100 are electrically connected to respective suspension pads 102 by the soldering device and method explained above in FIGS. 5A-5D.

Specifically, the bond head 72 is positioned adjacent one of the aligned slider and suspension pads 100, 102, and a solder ball 94 is melted inside the primary passage of the bond head 72 by a laser beam. Then, the melted solder ball 94 is jetted out of the bond head 72 by pressurized gas onto the slider and suspension pads 100, 102 (see FIG. 6), where it is reflowed between the slider and suspension pads 100, 102 to achieve the electrical connection. Once the jetting is complete, the bond head 72 is moved to deliver another melted solder ball jet onto the next aligned slider and suspension pads 100, 102. FIGS. 7 and 8 illustrates the reflowed solder ball connection between the slider pads 100 of the slider 20 and the suspension pads 102 of the suspension traces 98. As shown in FIG. 7, four electrical connections are provided to couple the slider 20 to the suspension traces 98. However, any other suitable number of electrical connections may be provided to couple the slider 20 to the suspension trace 98, e.g., 4-6 electrical connections.

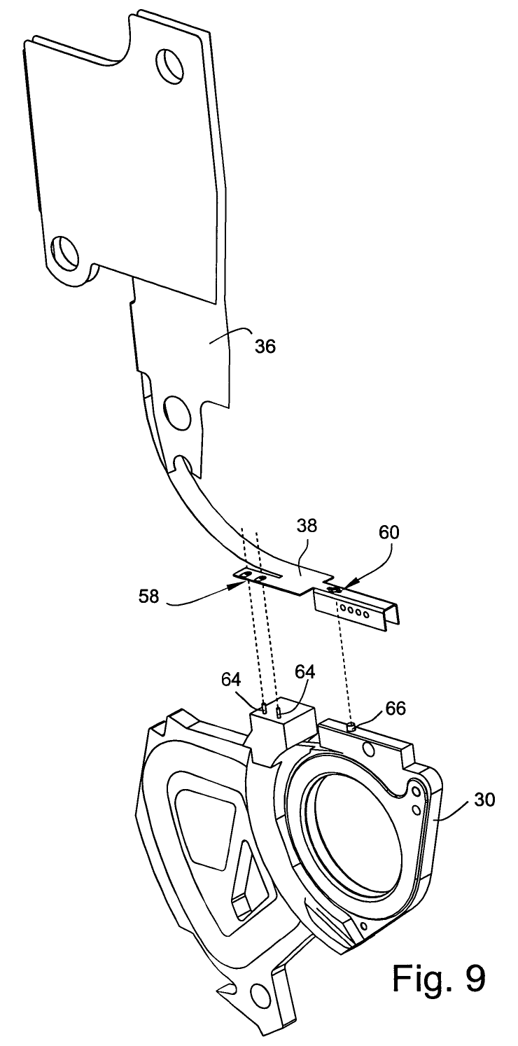

FIGS. 9-16 illustrate the soldering device and method of FIGS. 5A-5D being utilized to form electrical solder connections between the FPC 36 and the fantail spacer 30. As shown in FIG. 9, the FPC 36 is initially aligned with the fantail spacer 30 such that the grounding pin 66 aligns with the grounding pin connection pad 60 of the FPC assembly 38 and the voice coil leads 64 align with the voice coil connection pads 58 of the FPC assembly 38.

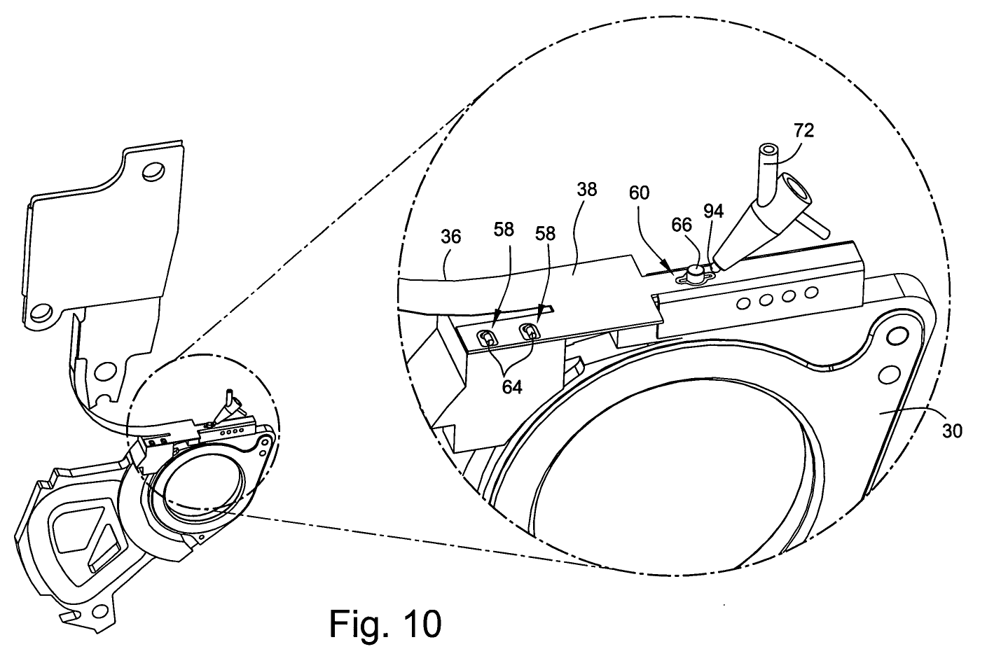

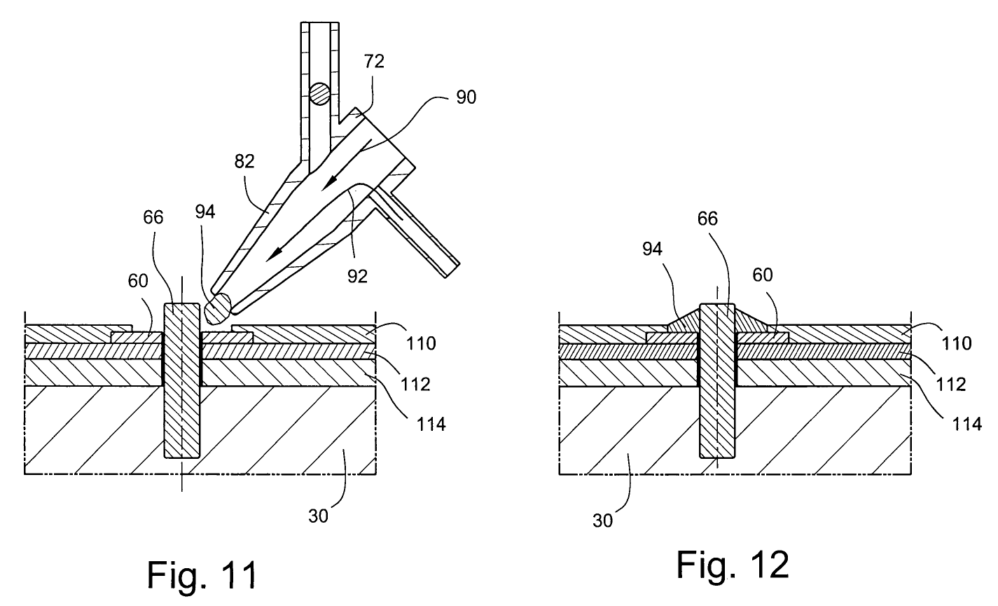

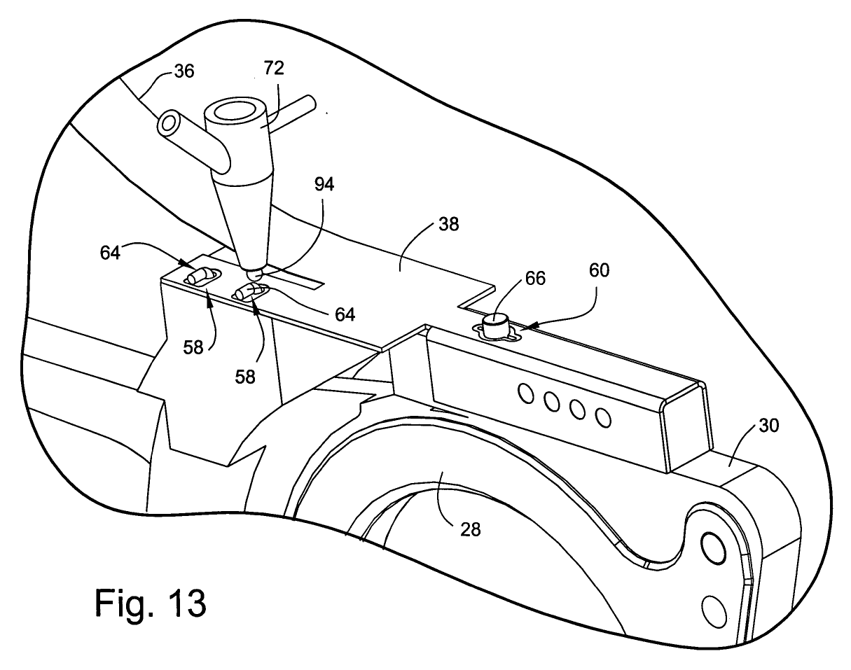

Next, the FPC 36 is engaged with the fantail spacer 30 such that the grounding pin 66 extends through an opening provided in the grounding pin connection pad 60 of the FPC 36 (as shown in FIGS. 10 and 11) and the voice coil leads 64 extend through respective openings provided in the voice coil connection pads 58 of the FPC 36 (as shown in FIG. 13). Then, the grounding pin connection pad 60 is electrically connected to the grounding pin 66 and the voice coil connection pads 58 are electrically connected to respective voice coil leads 64 by the soldering device and method explained above in FIGS. 5A-5D.

FIGS. 10-11 illustrate the grounding pin connection pad 60 being electrically connected to the grounding pin 66. In the illustrated embodiment, the FPC assembly 38 includes multiple layers including the grounding pin connection pad 60, a cover layer 110, a base layer 112, and a stiffener layer 114. As illustrated, the grounding pin 66 provided on the fantail spacer 30 extends through openings provided in each of the layers 60, 110, 112, 114. However, the FPC assembly 38 may have any suitable structure, and the grounding pin connection pad 60 may be positioned adjacent the grounding pin 66 in any suitable manner.

The bond head 72 is positioned adjacent the grounding pin 66 and grounding pin connection pad 60, and a solder ball 94 is melted inside the primary passage 82 of the bond head 72 by a laser beam 90. Then, the melted solder ball 94 is jetted out of the bond head 72 by pressurized gas 92 onto grounding pin connection pad 60 and the grounding pin 66, where it is reflowed between the grounding pin connection pad 60 and the grounding pin 66 to achieve the grounded connection. It is noted that the bond head 72 may deliver one or more melted solder ball jets around the grounding pin 66 to achieve the grounded connection. FIG. 12 illustrates the reflowed solder ball connection between the grounding pin connection pad 60 of the FPC 36 and the grounding pin 66 of the fantail spacer 30. It is also noted that the grounded connection between the grounding pin connection pad 60 and the grounding pin 66 also functions to securely mount the FPC assembly 38 of the FPC 36 to the fantail spacer 30.

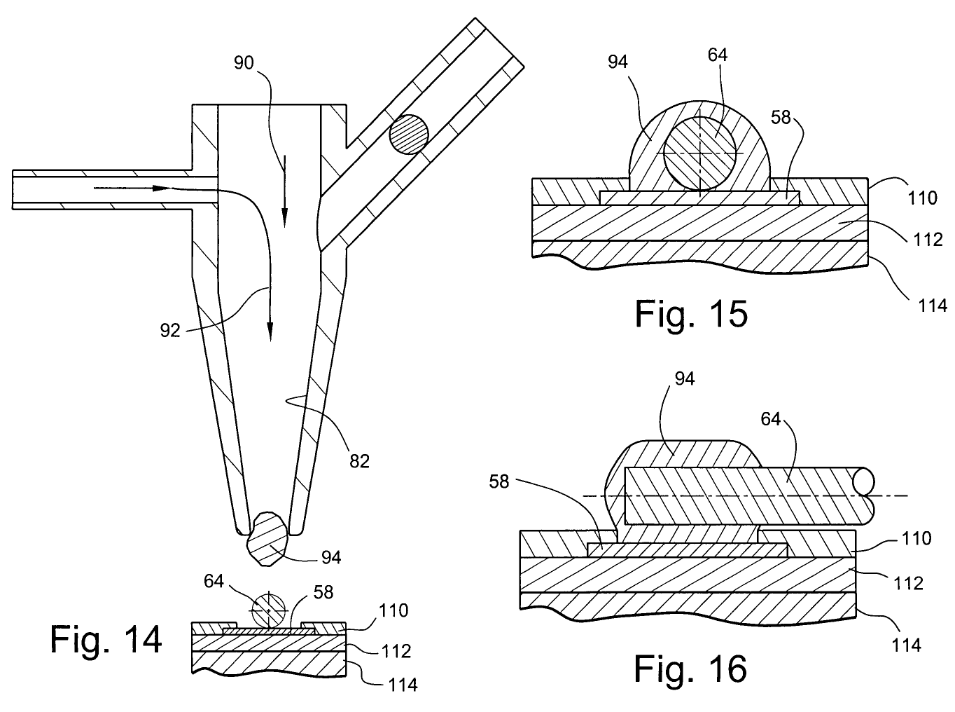

FIGS. 13-14 illustrate the voice coil connection pads 58 being electrically connected to respective voice coil leads 64. As noted above, the FPC assembly 38 includes multiple layers (i.e., voice coil connection pad 58, a cover layer 110, a base layer 112, and a stiffener layer 114) and each of the voice coil leads 64 extends through respective openings provided in each of the layers 58, 110, 112, 114. As illustrated, each voice coil lead 64 is bent such that each voice coil lead 64 extends generally parallel with the respective voice coil connection pad 58. However, the voice coil leads 64 and FPC assembly 38 may have any suitable structure, and the voice coil leads 64 may be positioned adjacent respective voice coil connection pads 58 in any suitable manner. Also, in the illustrated embodiment, two voice coil leads 64 are provided to couple the voice coil to the FPC assembly 38. However, any other suitable number of voice coil leads 64 may be provided to couple the voice coil to the FPC assembly 38, e.g., more than two.

The bond head 72 is positioned adjacent one of the aligned voice coil lead 64 and voice coil connection pad 58, and a solder ball 94 is melted inside the primary passage 82 of the bond head 72 by a laser beam 90. Then, the melted solder ball 94 is jetted out of the bond head 72 by pressurized gas 92 onto the voice coil lead 64 and voice coil connection pad 58, where it is reflowed between the voice coil lead 64 and voice coil connection pad 58 to achieve the electrical connection. It is noted that the bond head 72 may deliver one or more melted solder ball jets onto the voice coil lead 64 and voice coil connection pad 58 to achieve the electrical connection. Once the jetting is complete, the bond head 72 is moved to deliver another melted solder ball jet onto the next aligned voice coil lead 64 and voice coil connection pad 58. FIGS. 15-16 illustrate the reflowed solder ball connection between a voice coil connection pad 58 of the FPC 36 and a voice coil lead 64 provided on the fantail spacer 30. In the illustrated embodiment, the reflowed solder ball 94 surrounds the end portion of the voice coil lead 64 to achieve the electrical connection.

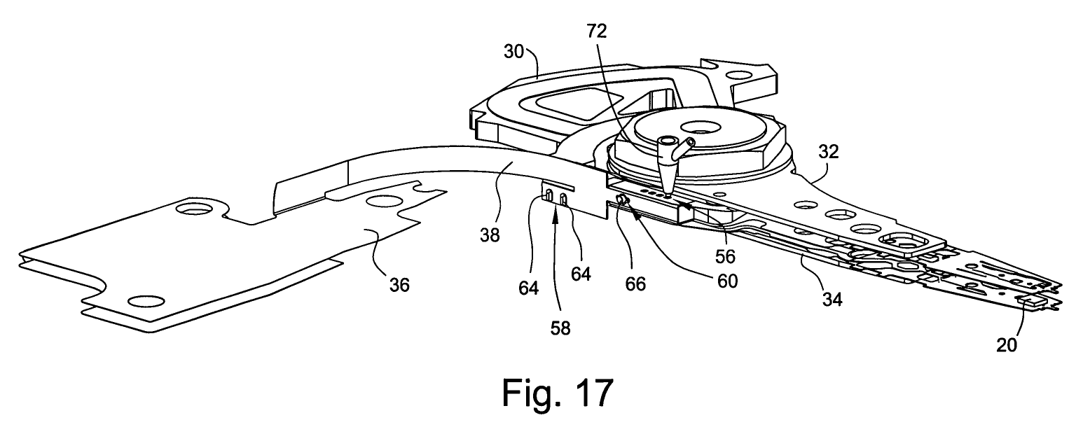

FIGS. 17-34 illustrate the soldering device and method of FIGS. 5A-5D being utilized to form electrical solder connections between the FPC and the suspension flexure of a HGA. The suspension flexure is initially engaged with the FPC such that the suspension pads on the suspension flexure align with respective FPC pads of the FPC assembly. Then, the suspension pads are electrically connected to respective FPC pads by the soldering device and method explained above in FIGS. 5A-5D.

FIGS. 17-22 illustrate a first embodiment of a HGA being electrically connected to a FPC. As shown in FIG. 17, the FPC 36 is initially assembled to the fantail spacer 30 by electrically connecting the voice coil connection pads 58 with voice coil leads 64 and electrically connecting the grounding pin connection pad 60 with the grounding pin 66 as explained above. Then, the HGAs 32 and 34 (with respective sliders 20 connected thereto) are secured by the securing means to the fantail spacer 30, which aligns the suspension pads 56 of the HGAs 32 and 34 with respective FPC pads 62 of the FPC assembly 38. As illustrated, the suspension pads 56 are parallel with respective FPC pads 62 such that the suspension pads 56 cover respective FPC pads 62. Also, the suspension pads 56 of the HGAs 32 and 34 are positioned on opposing sides of the fantail spacer 30 such that soldering occurs on both sides of the fantail spacer 30.

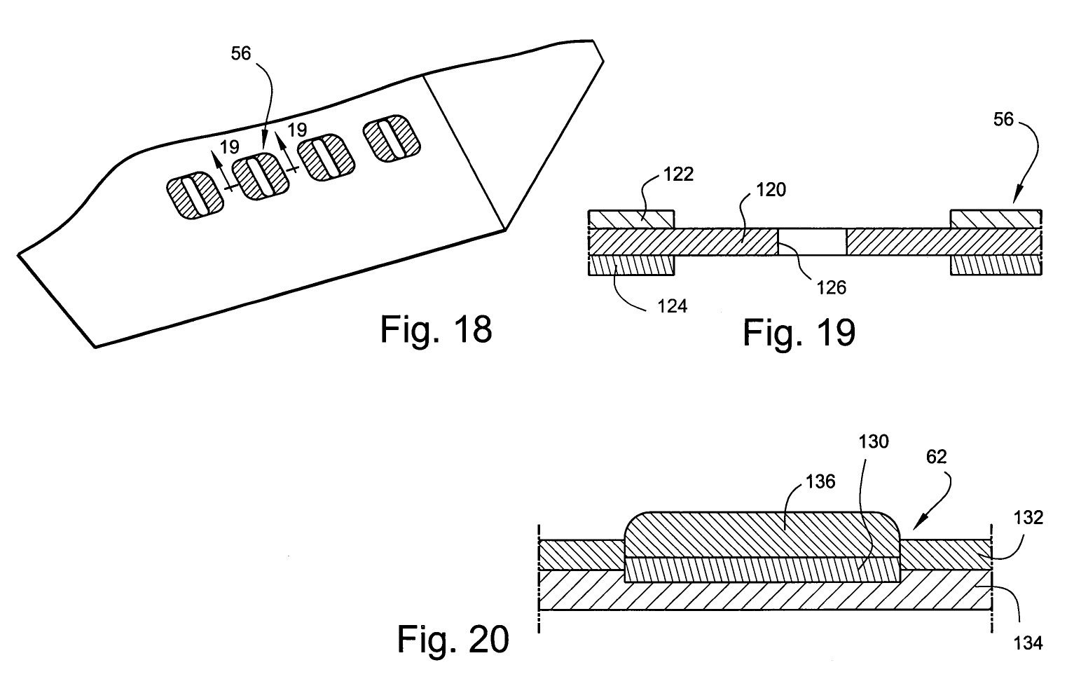

As shown in FIGS. 18 and 19, each suspension pad 56 includes multiple layers including a conductive bonding pad 120 and insulation layers 122, 124 on opposing sides of the bonding pad 120. As illustrated, an opening 126 is provided in the bonding pad 120 to allow connection with a respective FPC pad 62. As shown in FIG. 20, each FPC pad 62 includes multiple layers including a conductive bonding pad 130, a insulation layer 132, and a conductive layer 134. Also, a solder coating 136 is provided on the bonding pad 130 to facilitate the soldering process. However, the suspension pads 56 and FPC pads 62 may have any suitable structure, and the suspension pads 56 may be positioned adjacent respective FPC pads 62 in any suitable manner. Also, in the illustrated embodiment, four suspension pads 56 and four FPC pads 62 are provided to couple each HGA 32, 34 to the FPC assembly 38. However, any other suitable number of pads may be provided to couple each HGA 32, 34 to the FPC assembly 38, e.g., more than four.

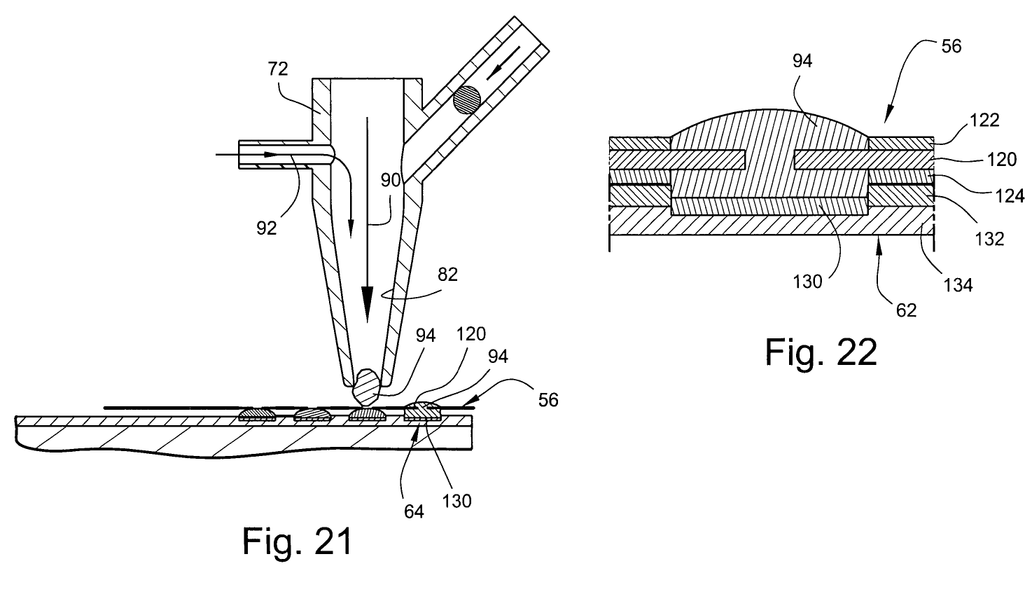

As shown in FIGS. 17 and 21, the bond head 72 is positioned adjacent one of the aligned suspension pad 56 and FPC pad 62, and a solder ball 94 is melted inside the primary passage 82 of the bond head 72 by a laser beam 90. Then, the melted solder ball 94 is jetted out of the bond head 72 by pressurized gas 92 onto the bonding pad 120, where it reflows onto the bonding pad 130 of the FPC pad 62 through the opening 126 to achieve the electrical solder connection. Once the jetting is complete, the bond head 72 is moved to deliver another melted solder ball jet onto the next aligned suspension pad 56 and FPC pad 62. FIG. 22 illustrates the reflowed solder ball connection between the suspension pad 56 on the suspension flexure and the FPC pad 62 of the FPC assembly 38. As illustrated, the solder coating 136 provided on the bonding pad 130 and the reflowed solder ball 94 join together to achieve the electrical connection.

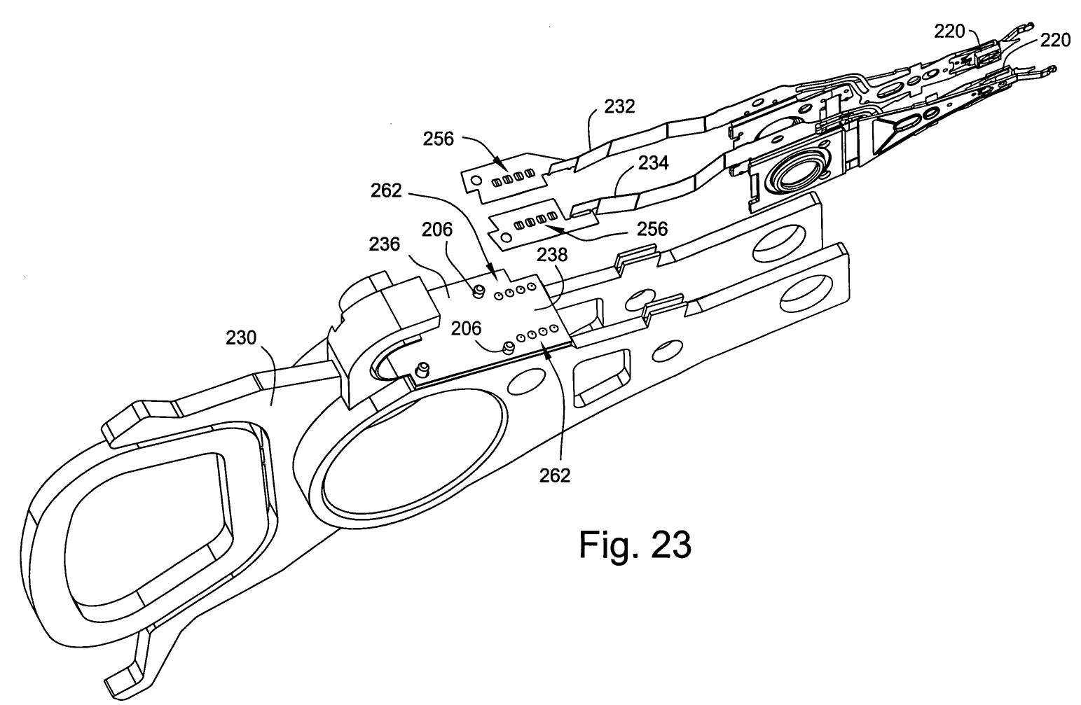

FIGS. 23-31 illustrate a second embodiment of a HGA being electrically connected to a FPC. As shown in FIG. 23, the HGAs 232 and 234 (with respective sliders 220 connected thereto) are initially aligned with the FPC 236 provided on the fantail spacer 230 such that the suspension pads 256 of the HGAs 232, 234 align with respective FPC pads 262 of the FPC assembly 238 of the FPC 236. As illustrated, the suspension pads 256 are parallel with respective FPC pads 262 such that the suspension pads 256 cover respective FPC pads 262. Also, the suspension pads 256 of the HGAs 232, 234 are positioned on the same side of the fantail spacer 230 such that soldering occurs on a single side of the fantail spacer 230.

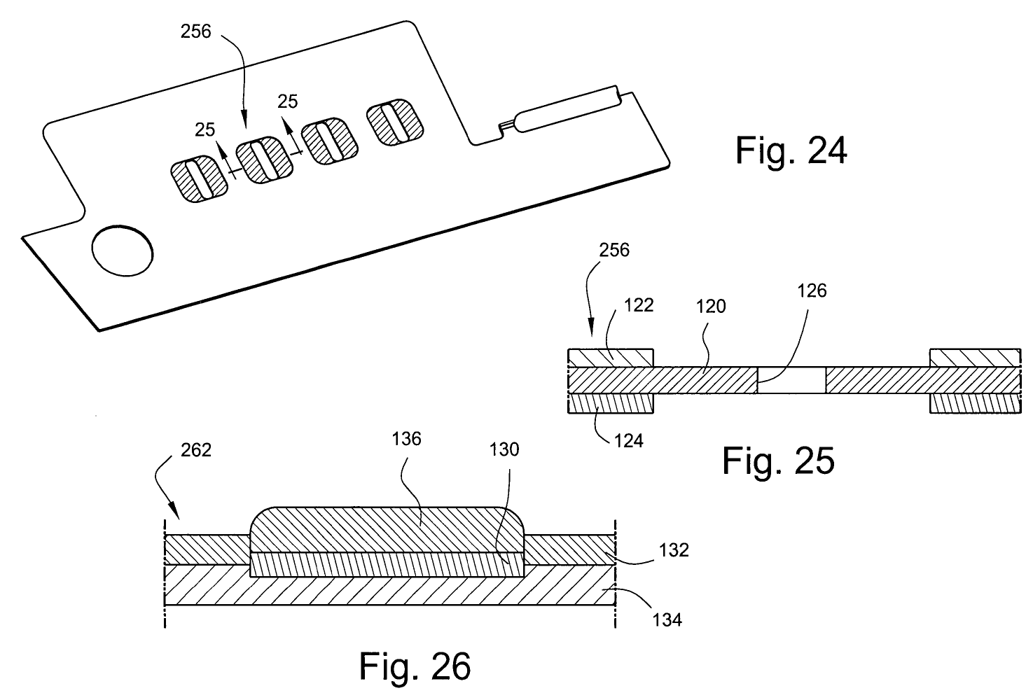

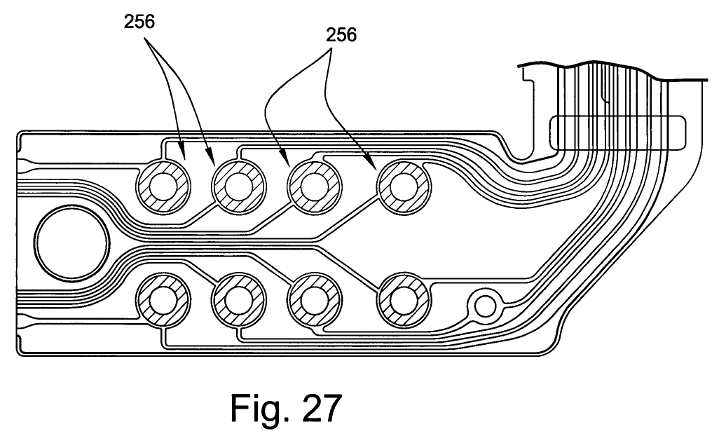

As shown in FIGS. 24 and 25, each suspension pad 256 includes multiple layers including a conductive bonding pad 120, and insulation layers 122, 124 on opposing sides of the bonding pad 120. As illustrated, an opening 126 is provided in the bonding pad 120 to allow connection with a respective FPC pad 262. As shown in FIG. 26, each FPC pad 262 includes multiple layers including a conductive bonding pad 130, a insulation layer 132, and a conductive layer 134. Also, a solder coating 136 is provided on the bonding pad 130 to facilitate the soldering process. However, the suspension pads 256 and FPC pads 262 may have any suitable structure, and the suspension pads 256 may be positioned adjacent respective FPC pads 262 in any suitable manner. Also, in the illustrated embodiment, four suspension pads 256 and four FPC pads 262 are provided to couple each HGA 232, 234 to the FPC assembly 238. However, any other suitable number of pads may be provided to couple each HGA 232, 234 to the FPC assembly 238, e.g., eight suspension pads 256 as shown in FIG. 27.

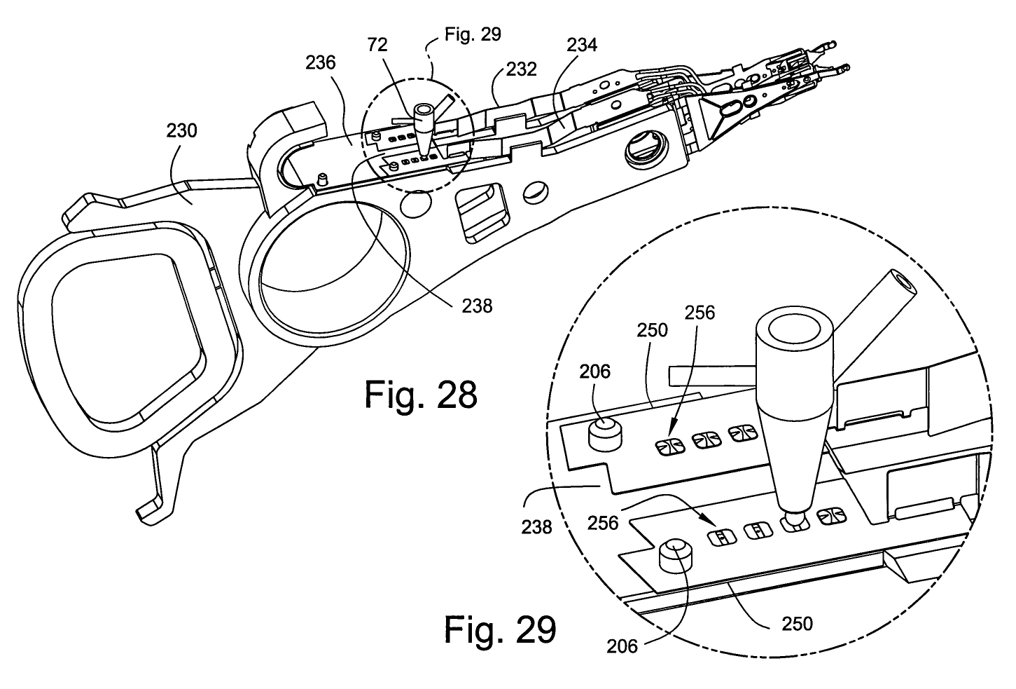

As shown in FIGS. 28 and 29, the suspension flexure 250 of each HGA 232, 234 is engaged with the FPC assembly 238. As illustrated, the FPC assembly 238 includes pins 206 that extend through respective openings provided in the suspension flexure 250 of each HGA 232, 234 to align and position the suspension pads 256 of the HGAs 232, 234 with respective FPC pads 262 of the FPC assembly 238.

As shown in FIGS. 28-30, the bond head 72 is positioned adjacent one of the aligned suspension pad 256 and FPC pad 262, and a solder ball 94 is melted inside the primary passage 82 of the bond head 72 by a laser beam 90. Then, the melted solder ball 94 is jetted out of the bond head 72 by pressurized gas 92 onto the bonding pad 120, where it reflows onto the bonding pad 130 of the FPC pad 262 through the opening 126 in the bonding pad 120 to achieve the electrical solder connection. Once the jetting is complete, the bond head 72 is moved to deliver another melted solder ball jet onto the next aligned suspension pad 256 and FPC pad 262. FIG. 31 illustrates the reflowed solder ball connection between the suspension pad 256 on the suspension flexure 250 and the FPC pad 262 of the FPC assembly 238. As illustrated, the solder coating 136 provided on the bonding pad 130 and the reflowed solder ball 94 join together to achieve the electrical connection.

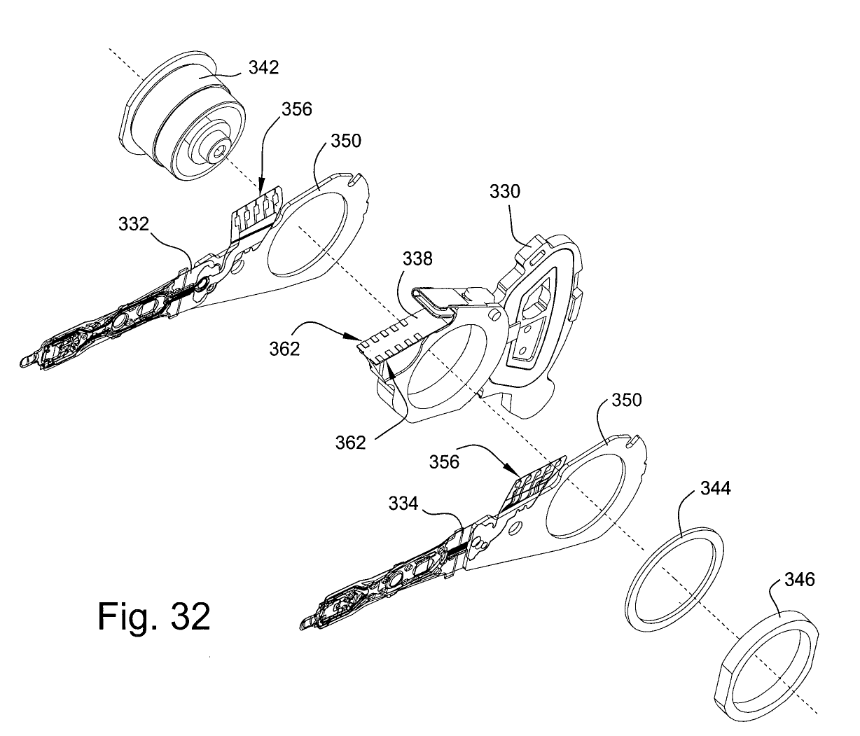

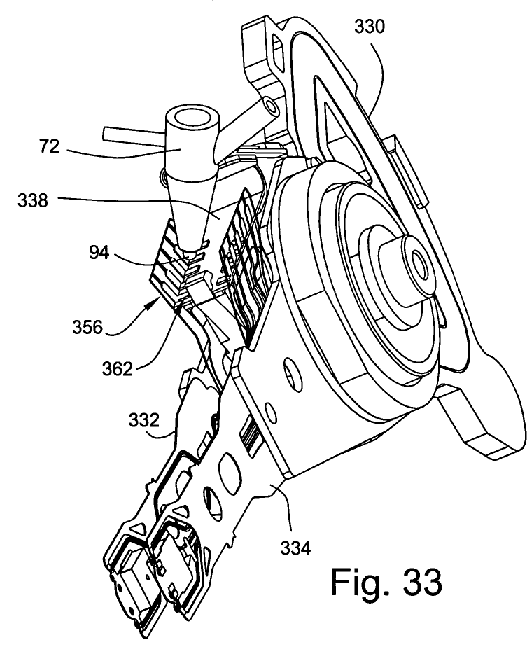

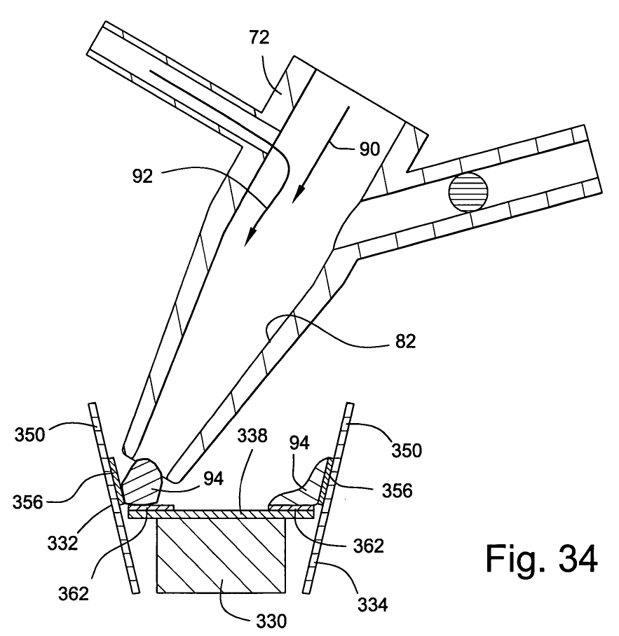

FIGS. 32-34 illustrate a third embodiment of a HGA being electrically connected to a FPC. As shown in FIGS. 32 and 33, the suspension base plate 350 of respective HGAs 332, 334 (with respective sliders 320 connected thereto) are initially aligned with the fantail spacer 330, and then coupled thereto by a plurality of securing means, e.g., bearing 342, washer 344, and nut 346. When coupled, the suspension pads 356 of the HGAs 332, 334 align with respective FPC pads 362 of the FPC assembly 338. As best shown in FIGS. 33 and 34, the suspension pads 356 are transverse, e.g., generally perpendicular, with respective FPC pads 362. Also, the suspension pads 356 of the HGAs 332, 334 are adjacent the same side of the fantail spacer 330 such that soldering occurs on a single side of the fantail spacer 330.

The suspension pads 356 and FPC pads 362 may have any suitable structure, and the suspension pads 356 may be positioned adjacent respective FPC pads 362 in any suitable manner. Also, in the illustrated embodiment, five suspension pads 356 and five FPC pads 362 are provided to couple each HGA 332, 334 to the FPC assembly 338. However, any other suitable number of pads may be provided to couple each HGA 332, 334 to the FPC assembly 338.

As shown in FIGS. 33 and 34, the bond head 72 is positioned adjacent one of the aligned suspension pad 356 and FPC pad 362, and a solder ball 94 is melted inside the primary passage 82 of the bond head 72 by a laser beam 90. Then, the melted solder ball 94 is jetted out of the bond head 72 by pressurized gas 92 onto the suspension and FPC pads 356, 362, where it is reflowed between the suspension and FPC pads 356, 362 to achieve the electrical connection. Once the jetting is complete, the bond head 72 is moved to deliver another melted solder ball jet onto the next aligned suspension and FPC pads 356, 362. FIG. 34 illustrates a reflowed solder ball connection (i.e., on the right side) between the suspension pad 356 on the suspension flexure of one HGA and the FPC pad 362 of the FPC assembly 338.

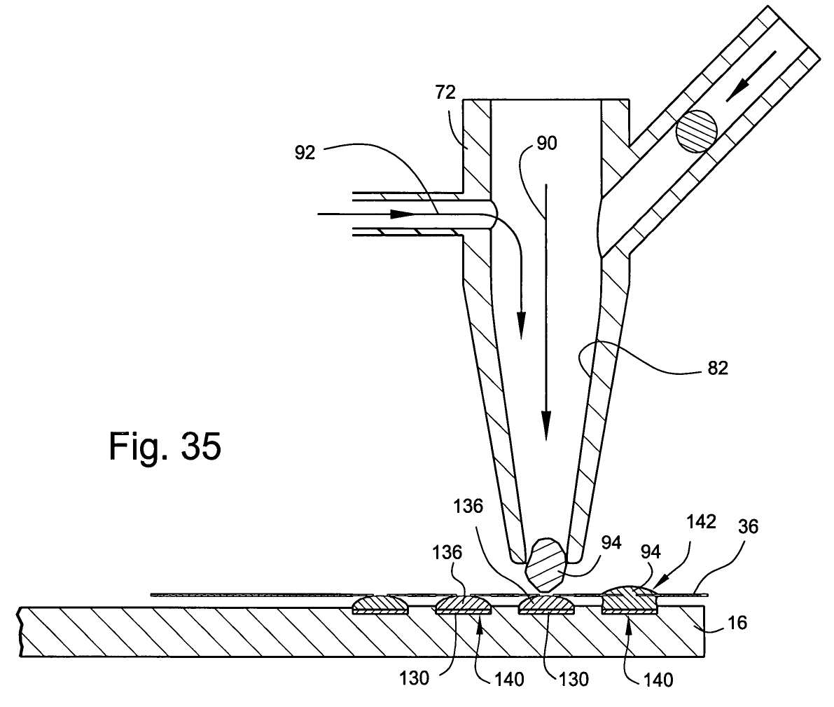

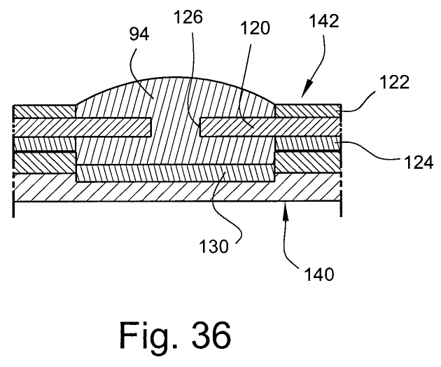

FIGS. 35 and 36 illustrate the soldering device and method of FIGS. 5A-5D being utilized to form electrical solder connections between the FPC 36 and the PCBA 16. The electrical solder connections between the FPC 36 and the PCBA 16 are substantially similar to the electrical solder connections between the FPC 36, 236 and the suspension flexure of a HGA 32, 34, 232, 234 described above in FIGS. 17-31.

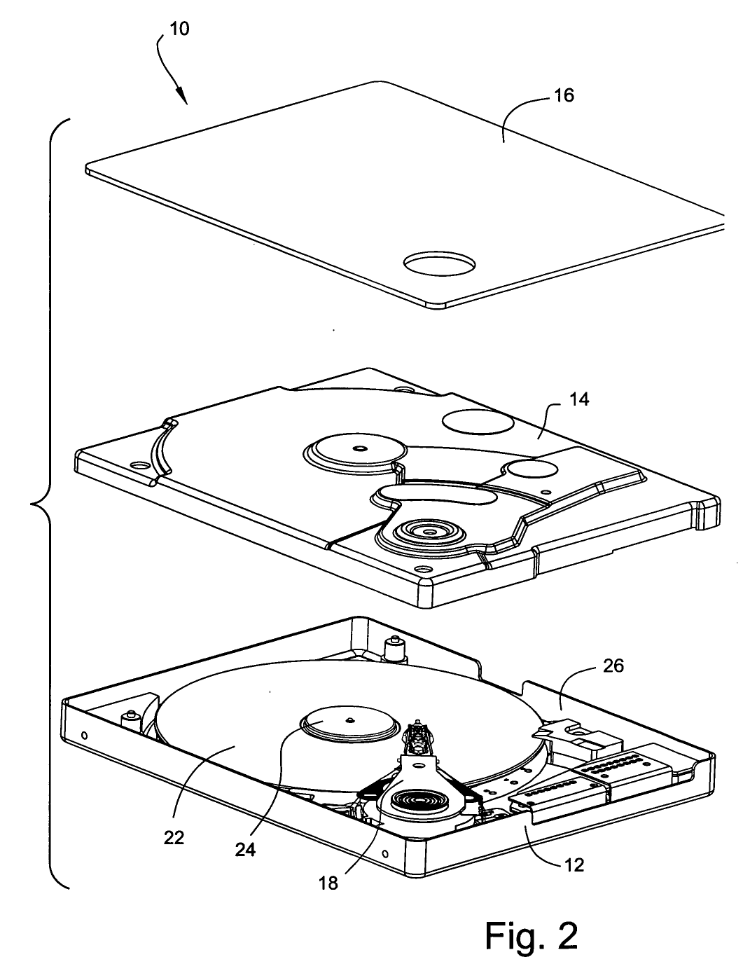

Specifically, the PCBA 16 is initially mounted to the top cover 14 or motor base 26 of the disk drive unit 10 to align PCBA pads 140 provided on the PCBA 18 with respective FPC pads 142 (e.g., see FIG. 2) provided on the FPC 36. As shown in FIG. 35, the PCBA pads 140 are parallel with the FPC pads 142 such that the PCBA pads 140 cover the FPC pads 142. Then, the PCBA pads 140 are electrically connected to respective FPC pads 142 by the soldering device and method explained above in FIGS. 5A-5D.

Each FPC pad 142 includes multiple layers including a conductive bonding pad 120 and insulation layers 122, 124 on opposing sides of the bonding pad 120. An opening 126 is provided in the bonding pad to allow connection with a respective PCBA pad 140. Each PCBA pad 140 includes multiple layers including a conductive bonding pad 130 and a solder coating 136 provided on the bonding pad 130 to facilitate the soldering process. However, the FPC pads 142 and PCBA pads 140 may have any suitable structure, and the PCBA pads 140 may be positioned adjacent respective FPC pads 140 in any suitable manner. Also, any suitable number of pads may be provided to couple the PCBA 16 to the FPC 36.

As shown in FIG. 35, the bond head 72 is positioned adjacent one of the aligned PCBA pad 140 and FPC pad 142, and a solder ball 94 is melted inside the primary passage 82 of the bond head 72 by a laser beam 90. Then, the melted solder ball 94 is jetted out of the bond head 72 by pressurized gas onto the bonding pad 120 of the FPC pad 142, where it reflows onto the bonding pad 130 of the PCBA pad 140 through the opening 126 in the FPC pad 142 to achieve the electrical solder connection. Once the jetting is complete, the bond head 72 is moved to deliver another melted solder ball jet onto the next aligned PCBA pad 140 and FPC pad 142. FIG. 36 illustrates the reflowed solder ball connection between the PCBA pad 140 on the PCBA 16 and the FPC pad 142 of the FPC 36. As illustrated, the solder coating 136 provided on the PCBA pad 140 and the reflowed solder ball 94 join together to achieve the electrical connection.

The soldering device and method of FIGS. 5A-5D may be utilized to form electrical solder connections between other suitable components of a disk drive unit. For example, the soldering device and method of FIGS. 5A-5D may also be utilized to form electrical solder connections between the motor flex and PCBA and between the motor flex and the FPC.

Also, it is noted that the pads used in the above-noted electrical solder connections may be constructed from any suitable material and may have any suitable size.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A soldering device for forming electrical solder connections in a disk drive unit, the soldering device comprising:
a bond head including a housing that provides a primary passage and two supplemental passages that communicate with the primary passage;
a laser unit coupled to the primary passage, the laser unit operable to direct a laser beam through the primary passage;
a pressurized gas supply coupled to one of the supplemental passages, the pressurized gas supply operable to deliver pressurized gas through the one supplemental passage and into the primary passage; and
a solder ball supply coupled to the other of the supplemental passages, the solder ball supply operable to deliver a single solder ball through the other supplemental passage and into the primary passage,
wherein the primary passage has a tapered configuration structured to maintain a solder ball within the primary passage to allow a laser beam from the laser unit to act upon the solder ball before the solder ball is discharged from the bond head by the pressurized gas.

2. The soldering device according to claim 1, wherein the inner diameter of the primary passage gradually decrease towards an outlet.

3. The soldering device according to claim 2, wherein the inner diameter of the primary passage adjacent the outlet is sufficiently smaller than a diameter of a solder ball received from the solder ball supply.

4. The soldering device according to claim 1, wherein the solder ball supply delivers solder balls having controlled diameters.

5. The soldering device according to claim 1, wherein the laser beam is configured to melt and reflow the solder ball.

6. The soldering device according to claim 1, wherein the pressurized gas is an inert gas.

7. A method for forming electrical solder connections in a disk drive unit, the method comprising:
delivering a solder ball into a passage of a bond head;
melting the solder ball within the passage by a laser beam; and
discharging the melted solder ball from the passage by pressurized gas onto a desired solder location.

8. The method according to claim 7, further comprising maintaining the solder ball within the passage adjacent an outlet of the bond head to allow a laser beam to melt the solder ball before the solder ball is discharged from the outlet by pressurized gas.

9. A bond head for a soldering device that forms electrical solder connections in a disk drive unit, the bond head comprising:
a housing that provides a primary passage structured to receive a solder ball from a solder ball supply,
the primary passage having a tapered configuration in which an inner diameter of the primary passage adjacent an outlet is sufficiently smaller than a diameter of a solder ball received from the solder ball supply whereby the solder ball is maintained within the primary passage adjacent the outlet.

10. The bond head according to claim 9, wherein the inner diameter of the primary passage gradually decrease towards the outlet.

11. A method for forming an electrical solder connection between a slider and a suspension of a HGA, the method comprising:
mounting the slider to the suspension such that a slider pad of the slider is adjacent to a suspension pad of the suspension;
positioning a bond head adjacent to the slider pad and the suspension pad;
delivering a solder ball into a passage of the bond head;
melting the solder ball within the passage by a laser beam; and
discharging the melted solder ball from the passage by pressurized gas onto the slider pad and the suspension pad where it is reflowed between the slider pad and the suspension pad to achieve the electrical solder connection.

12. A method for forming an electrical solder connection between a grounding pin provided on a fantail spacer and a FPC, the method comprising:
mounting the FPC to the fantail spacer such that the grounding pin is adjacent to a connection pad of the FPC;
positioning a bond head adjacent to the grounding pin and the connection pad;
delivering a solder ball into a passage of the bond head;
melting the solder ball within the passage by a laser beam; and
discharging the melted solder ball from the passage by pressurized gas onto the grounding pin and the connection pad where it is reflowed between the grounding pin and the connection pad to achieve the electrical solder connection.

13. A method for forming an electrical solder connection between a voice coil lead provided on a fantail spacer and a FPC, the method comprising:
mounting the FPC to the fantail spacer such that the voice coil lead is adjacent to a connection pad of the FPC;
positioning a bond head adjacent to the voice coil lead and the connection pad;
delivering a solder ball into a passage of the bond head;
melting the solder ball within the passage by a laser beam; and
discharging the melted solder ball from the passage by pressurized gas onto the voice coil lead and the connection pad where it is reflowed between the voice coil lead and the connection pad to achieve the electrical solder connection.

14. A method for forming an electrical solder connection between a suspension flexure of a HGA and a FPC, the method comprising:
mounting the suspension flexure to the FPC such that a suspension pad of the suspension flexure is adjacent to a connection pad of the FPC;
positioning a bond head adjacent to the suspension pad and the connection pad;
delivering a solder ball into a passage of the bond head;
melting the solder ball within the passage by a laser beam; and
discharging the melted solder ball from the passage by pressurized gas onto the suspension pad and the connection pad where it is reflowed between the suspension pad and the connection pad to achieve the electrical solder connection.

15. A method for forming an electrical solder connection between a PCBA and a FPC, the method comprising:
mounting the PCBA to the FPC such that a PCBA pad of the PCBA is adjacent to a FPC pad of the FPC;
positioning a bond head adjacent to the PCBA pad and the FPC pad;
delivering a solder ball into a passage of the bond head;
melting the solder ball within the passage by a laser beam; and
discharging the melted solder ball from the passage by pressurized gas onto the PCBA pad and the FPC pad where it is reflowed between the PCBA pad and the FPC pad to achieve the electrical solder connection.
